(19) United States
(12) Patent Application Publication
(10) Pub. No.: US 2013/0185182 A1
(43) Pub. Date: Jul. 18, 2013

(54) Opinion Based Currency For Economic Optimizations Using Publicly Available Data

(71) Applicants: Lawrence Au, Vienna, VA (US); Stephen Candelmo, Bethesda, MD (US)

(72) Inventors: Lawrence Au, Vienna, VA (US); Stephen Candelmo, Bethesda, MD (US)

(21) Appl. No.: 13/744,289

(22) Filed: Jan. 17, 2013

Related U.S. Application Data
(60) Provisional application No. 61/587,513, filed on Jan. 17, 2012.

(51) Int. Cl. G06Q 40/00

(52) U.S. Cl. CPC G06Q 40/00
USPC 705/35

(57) ABSTRACT

A system and method for transparently valuing a market of fungible opinions, as a basis for more efficiently motivating individuals in society to make actionable resource allocation decisions, including buying and selling and contracting thereof, by valuing individual published opinions and compensating holders of opinions for making valuable contributions to society, as well as compensating providers of physical property and labor resources for providing those resources to society, on the evidence of favorable opinions about specific contributions to society.

This application claims priority to U.S. Provisional Application No. 61/587,513, filed on Jan. 17, 2012, titled “Opinion Based Currency For Economic Optimizations Using Publicly Available Data”, the entire contents of which are hereby incorporated by reference herein.

### BACKGROUND OF THE INVENTION

The advent of the Internet has reduced the cost of publishing information nearly to zero. That, and increases in global literacy have revolutionized the ratio of publicly available information to privately available information. Before the year 1970, the amount of privately available information to each individual, characterized by acquaintances, books on hand, information learned during academic education, and on the job learning, outweighed the value of publicly available information, such as public libraries. The advent of low cost publishing on the Internet has made it preferable to find answers to more useful information, for everyday needs, from the public Internet rather than privately held information. The tipping point was reached in the last year or so with the shift towards web browser equipped smartphones and away from traditional cellphones.

Consequently, all the methods and systems for sharing private data, such as person to person phone calls, in-person conversations, classrooms, seminars and tradeshows must now compete with methods delivering public information on the Internet. Since the value of data follows Metcalfs Law: n(n−1)/2, where n is the quantity of available data, the value and preference for public data over private data will soon be exponentially overwhelming.

Thus, future methods and systems for sharing data must be rebuilt to be consistent with public access needs, and thus they will fundamentally differ from earlier systems constructed for private data. For instance, trust and verification for private data relies heavily on interpersonal long-term relationships. Public data currently lacks similar trust and verification capabilities, and due to the vastly more dynamic nature of public data, public data requires entirely more dynamic methods of validating trustworthiness.

Internet consumer reviews are an interesting example of massive public data whose Metcalf value has exceeded private data. Basically, it is not longer possible for a group of acquaintances to know as much as Amazon reviews describe about the universe of products. Nor is possible for even an entire set of consumer oriented magazines to describe as much as the Amazon reviews describe. Consequently, people have been forced to read five to twenty reviews per purchasing decision on Amazon, or Yelp, to infer the truth of what is reviewed.

Amazon's implementation of unvalidated “usefulness” of reviews by capturing clicks on “this review was useful” and “this review was not useful” buttons reduced the load on readers somewhat, but that system has many flaws. There is early review bias: new reviews have no way to rank on top. Readers have no idea why any review was useful, and often one reader's useful review is another readers useless review. For instance, gourmet diners have very different needs than casual diners. Gourmet diners require distinctively and entertainingly prepared foods, whereas casual diners require quality on a budget. Why should they share the same “usefulness” button? And perhaps worst of all, these buttons are pressed by anonymous, nameless users, so cheating is totally undetectable. Anybody on the Internet can drop can lower a review to the bottom of rankings or raise a review to the top, for nefarious purposes. Since less than 1% of readers press these buttons, it is difficult for Amazon to, as a cure for cheating, force users to reveal their main digital identities prior to pressing these buttons, since the hurdle of registration would reduce the rate at which reviews are reviewed, further increasing early review bias. Some form of compensation or incentive is therefore is needed to enable this prerequisite of transparent digital identities.

Another way Metcalf's law has increased the power of social opinions is in social networks such as Facebook, Twitter and Youtube. There are no precedents for revolutions such as Arab Spring, in which people publish videos and pictures of calls to action, with the result being the overthrow of entire governments. This is Metcalf's power law value of public data overwhelming the power law of private data controlled by dictatorships. Again, the question of quality of opinions becomes the foremost discussion in these revolutions: quality based on truthfulness, sincerity, and value of society.

Thus validation, taken for granted as a background task in the early private data dominated version of human society, has now been pushed to the foreground in the newer public data version of society. It is therefore necessary to budget more resources, both technical resources and pure labor, to measure the quality of opinions.

Simultaneously, the expansion from private to public worlds entails a more sophisticated and less provincial method of quality control. For truth is no longer sought within the small village of the 120 or so mutually familiar acquaintances that one can reasonably keep in touch with, but sought within networks of mutually related ideas, which one can reasonably believe in. The new quality control must be optimized for this far more dynamic universe of ideas, bringing to bear new combinations of insights to restore a personal sense of direct contributions to the social good.

This new quality control will attract a greater fraction of human efforts in the new society than the older society, because the role of quality control, and scientific measurements of truthfulness are now shifting to the forefront, and the role of superstition and clubby networks is receding from a shift to transparency brought on by the plummeting cost of Internet data access.

### SUMMARY OF THE INVENTION

The present invention enables society to shift rapidly and efficiently from a economy based in privately verified opinions to a society based in publicly verified opinions. Key to this transition is a seamless mechanism for moving specific opinions from a private domain to a public domain. The free publication of opinions in blogs and consumer reviews is part of this movement, but the current economy rewards authorship of this crucial information in a highly inconsistent and erratic set of rewards. Bloggers may place contextual ads on their blog pages, and authors of consumer reviews may receive points redeemable for discount coupons, but the quality and utility of what they write is not consistent with, nor even proportional to, the compensation they receive. Instead, the strength of advertiser budgets and timing of promotional marketing campaigns controls the compensation amounts. As a result, individual blogs and consumer reviews are even less trusted by readers, forcing readers to resemble the ancient Greek philosopher Diogenes, who, as a protest, equipped himself with a lamp to search for “an honest man”, these readers read ever more and more reviews searching for grains of truth written by the two-thirds of reviews written without blatant emotional or economic bias. A research study by Cornell by Ott, Choi, Cardie and Hancock showed that humans are only 50% to 60% accurate when classifying reviews as either truthful or fraudulent. Since thinly reviewed (having only a handful of reviews) products and services greatly outnumber frequently reviewed products and services, (the “long tail” distribution of goods and services) most products and services are easy targets of review fraud. For instance, a web site called Fiverr, at http://fiverr.com/, offers to write glowing reviews for $5 dollars. At that rate, twenty or thirty dollars of Fiverr reviews would be enough to dominate reviews for most products or services.

The present invention removes the barriers of distrust separating readers and writers, by directly monetizing opinions for truthfulness, authenticity and utility. By directly monetizing the value of public writing for the public good, the present invention eliminates the provincial and self-serving barriers of distrust which separate reader from writer, and separate producer and consumer. This direct path is essential for restoring public trust in the economy, public trust in measurements of economic progress, and to eliminate the bureaucratic stranglehold that self-serving institutions have placed upon society.

Currency, such as dollars and pounds, have for thousands of years provided a medium of exchange to make goods fungible within the global economy. As that economy has shifted from a basis in raw materials to finished materials to a new basis in ideas, such as patents and copyrights, the older forms of currency have been enhanced with legal contracts to make movements of currency reflect the changing basis in society. For instance, contracts on the future value of ideas, such as patents, incorporate notions of time and increasing valuations (patent fees).

The shift from private to public data as a basis for the opinions in the economy necessitates a shift to a new form of contracts between the producers of opinions (writers) and the consumers of opinions (readers). The present invention incorporates contracts with built-in validation systems as part of the real-time valuation of a new kind of currency, a currency based in opinions.

Just as a gold-backed currency puts its trust in the finite value of a limited quantity of precious metal, a new currency of fungible, standardized, validated opinion credits puts trust in the total value of all opinions. But unlike gold, whose value is a bounded finite number (the ounces of gold humanity has on hand times its price per ounce) opinions can be improved over time, and for the long run, unlike gold, the economic sum value of all credible opinions is unbounded: it is the power of all human knowledge. The infinite value of credible knowledge, distilled into verified opinions, suits the greater aspirations of humanity, and so over time, a transition from a precious metal based currency to an opinion based currency will better suit humanity's goals, by shifting the focus of society from a zero-sum game such as the ownership allocation of gold, to a more humane and optimistic collaboration between all peoples.

A government-back currency functions as a blunt approximation to an opinion based currency, through elections which periodically validate a handful of opinions that sway elections. This sparse validation is insufficient to cover a dynamic economy, effectively bottling up creativity and blocking most creative options. The present invention provides a more powerful free economy approach to validation, thus enabling individuals to contribute and be rewarded on an continual, customer to customer, individual basis, for the greater good. By publicly and transparently shifting the basis of currency from sporadic trust to continually verified trust, economies no longer depend on blunt ideas that are too big to allow to fail, such as treasury bill interest rates, gross national product targets, and insured commodity pricing. Instead, by applying opinion validation upon each decision of purchasing supply chains, economies can be directed toward more directly toward useful and flexible ideas, such as customer satisfaction and creative approaches to manufacturing, and these new ideas can be tried and vetted faster and in greater detail by political elections and corporate board level meetings.

As a corollary benefit, thorough application of such improved decision-making enables society to move from a payment-based economy to a reputation and opinion-based economy, in which resources are allocated directly from opinions to reputable service and product providers, just as they do in specific areas of non-profit work, in organizations such as Doctors Without Borders, which provides free medical care. As can be seen in the recent revolution in Libya, products and services can in the short term be delivered purely based on public opinions, without payments, by tweeting for redistribution of services. The present invention enables the quality of that delivery to be continually optimized, by treating quality of opinions to be more important than payments, as a focus for compensation.

### BRIEF DESCRIPTION OF THE DRAWINGS

FIG. 1 Internet Opinion Credit System Of Currency

FIG. 2 Curation Validation System

FIG. 3 Displacement Of Convention Currency Markets, Over Time

### DETAILED DESCRIPTION OF THE INVENTION

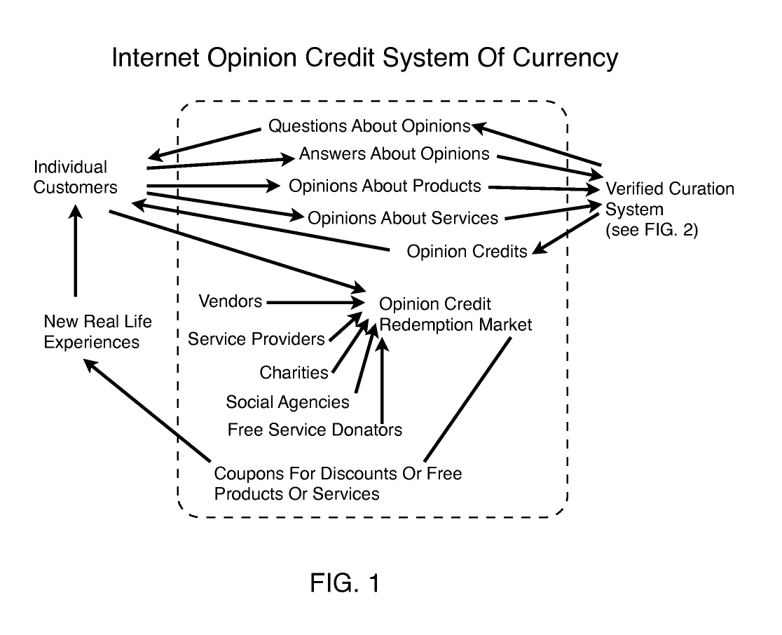

FIG. 1 shows a system and method for enabling a currency based on opinion valuations. The boundaries of the system are shown by the dashed line. Unlike a traditional marketplace based on payments, opinions themselves form the basis for actions. By validating opinions for quality, inferior opinions are replaced by superior opinions, and all decisions can be vetted by first hand witnesses, as soon as affected individual people can review their quality.

Inputs to the system are shown by arrows pointing away from Individual Customers, who submit Opinions About Products, Opinions About Services, Answers About Opinions (in response to Questions About Opinions), and redemption of Individual Customer Opinion Credits at the Opinion Credit Redemption Market.

Inputs to the system also come from Vendors, Service Providers, Charities, Social Agencies, Free Service Donators, who post goods and services which may be redeemed by Individual Customer Opinion Credits, or by discount coupons redeemed by Individual Customer Opinion Credits.

Inputs to the system also come from an authoritative Curation Validation System, which analyzes the credibility of opinions to categorize opinions by themes and by quality of opinion, to further send Questions About Opinions as input to the system, as well as input of commands to assign Opinion Credits to Individual Customers.

Outputs from the system are shown by arrows pointing towards Individual Customers, which show Customers receiving Questions About Opinions (whether their own or other opinions in dispute), and also receiving Opinion Credits, and also receiving Coupons For Discounts Or Free Products Or Services, via their redeemed Opinion Credits in the Opinion Credit Redemption Market.

Outputs from the system are also shown as arrows pointing towards the Curation Validation System, which receives Opinions About Products, Opinions About Services and Answers About Opinions.

What is novel about the present invention is that the Curation Validation System issues Opinion Credits based upon the relative quality of Opinions, in terms of their utility to society. This is a vast difference from a payment based on a net present value of future return payments on goods: instead of exchanging goods and promissory contracts about goods, the present invention exchanges opinions about goods, and opinions about services. Rather than allowing the setting the value of transactions free of characterization by opinions, and free of public disclosure, the present invention requires opinions to characterize and contextualize transactions within public opinions which are potentially subject to public investigations. The present invention encourages and supports full disclosure in potentially all economic transactions, by requiring individual public posted opinions to back each and every economic transaction within a novel system of economic currency. The present invention also differs from prior art, in that the present invention directly links economic currency transactions to public rather than private reporting contexts. For instance, secret or untraceable transactions are suppressed by public reporting requirements, so that only by creating false digital identities can such transactions continue, and by delaying or shutting down suspicious transactions or suspending suspicious digital identities, most secret or untraceable transactions can be suppressed from this novel currency.

Portions of this transparency already exist with non-profit organizations providing free services, but the present invention adds a Curation Validation System to continually improve the basis for allocating economic resources within the system, based in general on statistical, text analytical measures of quality of opinions, supplemented by actual individual consumer feedback. Engagement of voice of the customer sentiment, both through monitoring of social media feeds using automatic text analytic processing, and by directly reaching out to consumers, enables resource allocations to be accurate and adjusted in real-time, bypassing the slowness of traditional market and purchasing bureaucracies, whether in government or private corporations.

The volume of opinions involved, as well as their diversity, and the number of people dealing with them as a result, would have been impossible to handle within a single system, before the development of Internet smartphones. However, from now, and into the future, the direct connections between individual persons over the Internet are more than capacious enough for that data traffic, in a world where most or many adults have access to smartphones.

By curating the relative quality of Opinions, in terms of their utility to society, the present invention assumes responsibility for seeking resolution for disagreements which span the wide variety of opinions voiced by an actual society. Compared to the narrow span of opinions for which a dictatorship is responsible for, and even the wider span the a democracy is responsible for, this responsibility is huge. In this enormous span, everybody's opinions matter, except for opinions of people shown (by curation) to be mentally incompetent. Though the cost of shouldering this responsibility is high, the cost of evading the responsibility is even higher, because the alienation caused by unrecognized and unresolved disputes has to be either resolved mentally, or else people's frustrations will reach a point of irreparable mental harm, culminating in criminal or warlike behavior, as an attempt to end their frustration and sense of irreparable harm, by any means necessary. For instance, James Jiler's work, as reported by CBS News, has shown that the six year recidivism (return to incarceration) rates are greatly reduced, to only 5 or 10 percent, down from 65% at Riker's Island Prison in New York City, by offering horticulture classes and outdoor horticulture training to convicted, imprisoned felons. It is a clear economic benefit to society to give theses classes and training to prisoners, because the cost of re-imprisoning them is vastly times higher than the cost of giving them this non-punitive, inspirational training, while they are in prison. Apparently, this non-punitive approach to reforming criminals is more cost-effective than traditional punitive approaches. Rather than only ruling for similar reform at presidential, supreme court or congressional level in government, the funding for such creative economic allocations could also be more comfortably tried in a less contentious setting, for instance within a prison system operating under transparent crowdsourced oversight, with the ultimate oversight resting in a Curation Validation System, which must carefully and transparently compare and choose opinions of this nature and complexity, at the limits of its ability, as well as quickly and transparently handle differences on opinion on simpler and clearer issues.

Though the cost of curating opinions at this level of transparency is high, the cost of avoiding transparent opinions is even higher, as the lower per capita economic output of nations which allow brutal suppression of opinions amply demonstrates. The transparency of allocating economic resources according to public opinion rather than private opinion reveals and disables the actions of self-serving market manipulators. For instance, if the Hunt brothers had attempted to “corner the market” in the precious metal market for silver, by buying up all offered silver contracts to increase silver prices to their sole benefit, under a transparent opinion based mechanism for allocating silver, all their attempts to redirect ownership of silver would have been public instead of private contracts, and as such, subject to scrutiny of an informed public, and squashed by an avalanche of public criticism. If however, they sought to redirect the ownership of silver in a way that benefited the public, to create for instance, a better use for the actual metal, then public opinion could have given them a discount on silver. The present invention substitutes verified opinions for superstitions as a basis for economic decisions, and as a corollary, substitutes altruistic intention for greed as a motivator of economic decisions.

The present invention takes advantage of lower smartphone and Internet bandwidth costs, which have been vanishing as suggested by Moore's Law, to implement a higher standard of full and totally transparent opinion utilization, to increase economic output. Since that higher standard can resolve the root differences in opinion between people, it can reduce the negative effects of disagreements, such as selfish and criminal behavior, as well as simultaneously increasing worker productivity and creativity. The present invention thus shifts the focus in society, from strategies that tear society apart, to better strategies that make society stronger, and thus implementation of the present invention should be budgeted on a scale of its economic benefit to society as a whole.

There is a significant cost of curation, however, because using opinions in place of payments means that the average person's dozen or so payment decisions a day become curated opinions. Customers are required to give opinions as to why something is good or bad, or at least whether some product or service met their needs, and these opinions have to be categorized into actions by the Curation Validation System. In the present invention, these opinions take the place of much terser or even invisible payment transactions of conventional currency systems. For instance, in prior art, regular monthly payments for electric bills may be automatically deducted from customer checking accounts. In the present invention, these transactions might be automatically generated as opinions about the quality of electric service for the billing period, with any complaint rising electric rates or about specific service outages included as needed, but which on most months would be the same exact opinion text as last month. Since the present invention encourages similar increases in the creating of opinions across all economic transactions, there will need to be automation in the reading and categorization of opinions to handle vastly higher volumes of written opinions.

This categorization is best done using some form of automated computational linguistics to make a routing decision as to which manual specialist(s) should complete the categorization. For instance, manual specialists may be assigned to automotive repair, within a job very much like an automotive insurance adjuster. However, for maximum economic efficiency, the most powerful forms of computational linguistics sentiment and thematic detection can automate the vast majority of categorization, particularly computational linguistics based on cognitive story analysis or automatic tracking of cognitive themes of intent, to find resolution of unsettling sentiments. In particular, the real-time feedback enabled by automated writer's guidance, as taught by U.S. patent application Ser. No. 12/382,754 titled “SYSTEM AND METHOD FOR ANALYZING TEXT USING EMOTIONAL INTELLIGENCE FACTORS” and patent applications claiming priority to that application, can substantially reduce both reader and writer labor costs, and recover otherwise hidden but important opinions by automatically interrogating writers, to encourage them to write greater authenticity and transparent readability, while they are actually writing produce reviews and other opinions.

For the Curation Validation System, the most important actionable categories are Questions, News, Deliveries, Disputes and Settlements. For simplicity, some of these categories may be omitted, and the Curation Validation System will still yield net economic value to society, but the preferred embodiment of the present invention categorizes opinions into some form of each of these categories.

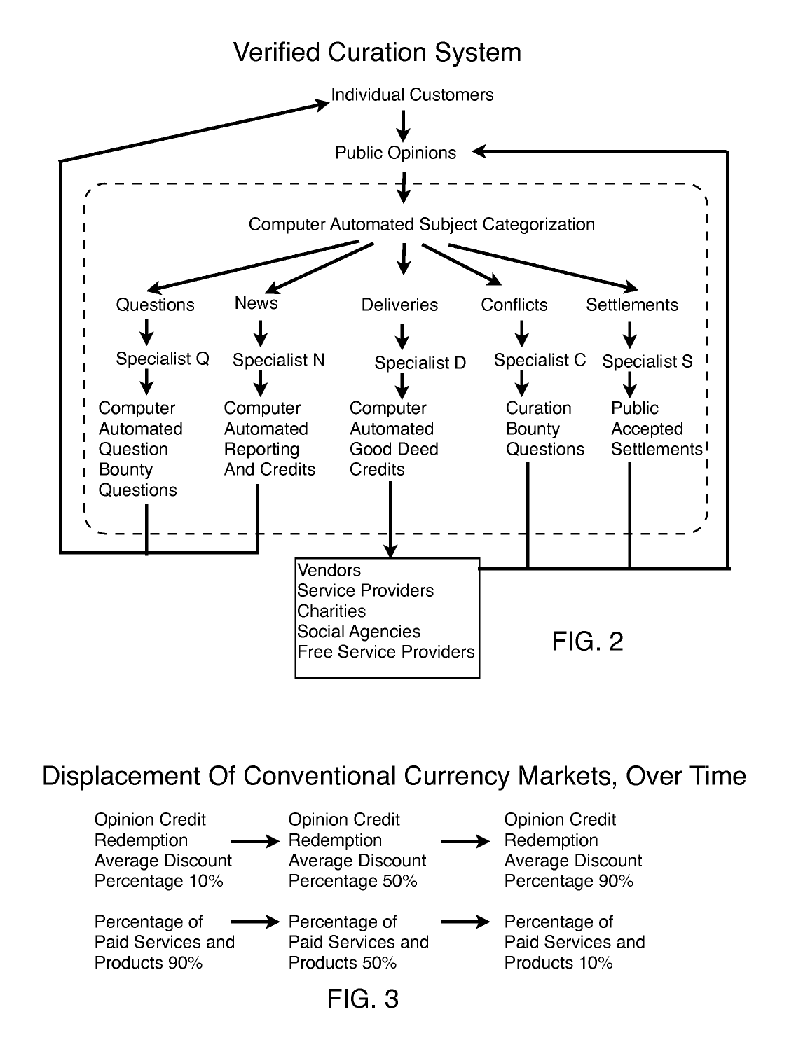

The boundary of the Curation Validation System are shown by the dashed line in FIG. 2. All opinions in FIG. 1, such as Opinions About Products, are indicated as a single processing node or category of data by Public Opinions in FIG. 2. The categories handled by Curation Validation System are shown as Questions, News, Deliveries, Disputes and Settlements. Each of these categories have a specific action target within the Curation Validation System. Opinions categorized as Questions are handled by a Specialist Q which may be a manual labor job or a task fully automated by computational linguistics, or some combination of both. The output of Specialist Q is a Computer Automated Answering Bounty, which is a bounty of Opinion Credits placed upon relevant answers to Questions, whose bounty magnitude is set by urgency of needs, which may be individual or social needs, expressed in Questions. For consistency, the same editorial standards on describing Bounty terms should be editorial standards for qualifying answers. Thus, if automated computational linguistics techniques are used to help categorize possible Bounty answers, these same techniques, and preferable even the same process using the same technology, should be applied to writing terms of Bounty and writing answers qualifying for Bounty. The preferred embodiment of the present invention is thus to apply real-time author's guidance to writers of both terms of Bounty and writers of answers qualifying for Bounty, to reduce time wasted on resolving ambiguities of intent and ambiguities in accomplishment. Further, the preferred embodiment of the present invention includes automated real-time author's guidance for both writers of both terms of Bounty and writers of answers qualifying for Bounty, to reduce the labor cost of guidance, by implementing guidance dialog in the form of chatterbot, chat-bot, and other guidance synthesized by computational linguistics.

This consistent and thorough application of computational linguistics enables the Computer Automated Subject Categorization to more efficiently do its task of categorizing opinions as candidate News opinions as qualifying for Bounty. At the same time, computational linguistics can route reports of new Bounty and Bounty Questions to specific Individual Customer's email, and news feed channels such as RSS, preferably to individuals or groups who have demonstrated expertise in the Bounty subject area.

Opinions categorized as News is handled by a Specialist N which may be a manual labor job, a task fully automated by computational linguistics, or some combination of both. The output of Specialist N is Computer Automated Reporting And Credits, which rewards the authors of opinions which either answered a Bounty Question, or rewards the authors of opinions which are considered newsworthy in the sense of journalism. Answers to Questions are routed back to original authors of Questions by Specialist N.

Opinions categorized as Deliveries are handled by Specialist D which may be a manual labor job, a task fully automated by computational linguistics, or some combination of both. The output of Specialist N is Computer Automated Good Deed Credits, which rewards people, by allocating Opinion Credits to Vendors, Service Providers, Charities, Social Agencies and Free Service Providers. Since Deliveries are opinionated descriptions of actual specific instances of services or products rendered, the opinions contained within become part of the knowledge of society describing which Vendors, Service Providers, Charities, Social Agencies and Free Service Providers are most helpful to society.

Opinions categorized as Conflicts are handled by Specialist C which may be a manual labor job, a task fully automated by computational linguistics, or some combination of both. The output of Specialist C are Curation Questions which are posted, as a public record, to be answered by either Individual Customers or Vendors, Service Providers, Charities, Social Agencies and Free Service Providers.

Since Conflicts, if unresolved between merchants and customers, must be resolved with the help of other parties, such conflicts often go to conventional courts or boards of arbitration. The present invention provides a new alternative to these prior art processes, by adding transparency and crowdsourcing of settlement terms: Bounties for proposed settlement terms are publicly posted for potential acceptance by parties to conflicts. This more flexible and encouraging system of justice adds the advantages of arbitration to the advantages of crowdsourcing and active participation by optimists incentivized by Opinion Credits. Creating a safe, congenial and easy forum for soliciting settlement terms directly from society, parties with a grievance can be heard and their need for sympathy, recognition of their suffering, and compassion can met authentically and immediately. Often, deprivation of authentic peer recognition is the root cause of aberrant actions, and the present invention can thus head off aberrant actions before irreparable damages occur.

Opinions categorized as Settlements, which are settlement terms to known conflicts, accepted by parties to conflict, are handled by Specialist S which may be a manual labor job, a task fully automated by computational linguistics, or some combination of both. The output of Specialist S is publication of settlement terms as well as Opinion Credits given to authors of settlement terms.

Since Deliveries, Conflicts and Settlements as taught by the present invention all are related tasks, the preferred embodiment of the present invention teaches that the technology of the Computer Automated Subject Categorization of their text should be automatically deployed to writers of that text, to encourage consistency, authenticity and clarity of writing for the benefit of all readers of that text, just as similar automated writers guidance can be deployed to writers of Questions and News in the present invention.

Since the present invention enables society to achieve faster and higher rates of validation of opinions, that greater output of public validated opinions, will according to Metcalf's Law, overwhelm to value of private, secret, unvalidated opinions. Because of that shift, driven by Metcalf's Law, both the Internet Opinion Credit System of FIG. 1 and the FIG. 2 Curation Validation System enable a shift from a currency operating in a society with low levels of trust, whose transactions are dominated by sellers setting pricing and mutually agreed negotiated prices, to a society dominated by high levels of trust, dominated by buyers setting prices.

Currently non-profit donations are the only commonly occurring buyer-priced markets. Here, partly from high levels of trust accorded non-profit institutions, people often are proud to have donated to a good cause, and are glad to have Facebook publish that transaction, or for larger donations, to have a plaque engraved for them in the non-profit recipient institution. The existence of high levels of trust between donor and recipient enable these relationships to flourish, and by increasing social levels of trust, the present invention enables a wider range of economic activities to be funded by donations. Thus, by rewarding investigative journalism with Opinions Credits, the present invention underwrites efforts to protect the public trust in public data, to further increasing social levels of trust and further increase the Metcalf Law value of that private data. The Opinion Credit and Donation aspects of the present invention are separate, but both contribute to high levels of social trust. The present invention thus is based upon increasing the level of social trust, by transparently verifying truths, and by offering incentives, or bounties, for work to be done as good social deeds.

Inherent to the same story, donors often feel the satisfaction of improving their social image by doing good deeds, and it has already been noted that donations and encouragement to donate on Facebook and other social networks dramatically increases the level of donations, because of the increased resonance in satisfaction that people feel when others witness their good deeds.

By actively publishing accounts of good deeds and validating them deeply through social networks of people who share common experiences (see, in FIG. 1, New Real Life Experiences of Individual Customers) as categorized by Curation Validation System Computer Automated Subject Categorization in FIG. 2, increased resonance of satisfaction in a buyer priced transaction can be further increased by immediate and automatic peer support within that social network. For instance, in 2007, mashable.com reported that the band Radiohead sold 1.2 million downloads of the album “In Rainbows” offered for buyer-set pricing, receiving an average donation of 8 dollars in one week, thus bringing in nearly ten million dollars in profit. Some fans commented with remarks along the lines of the “fan in me wants to pay $70 dollars but the person trying to make ends meet wants to pay $7 dollars.” Music industry observers may be skeptical that the “In Rainbows” release demonstrates a future pricing model, but there were no records of donor's digital identities, which enabled freeloaders to download without affecting their personal reputations. In contrast, the present invention requires authentication of digital identities, to discourage freeloading, and to encourage truthfulness in opinion making.

By thus increasing viability of opinions, as transactions, the actual value of services and goods may be set more efficiently than by the actions of advertising and discounting, since any set pricing level may be too high or too low, depending on the funds available to the buyer. On the whole, when thousands of copies of something are delivered, the buyer-priced donations average out in magnitude, which then is based what individual opinions of value. As long as that average magnitude is high enough for the seller to be satisfied, there is no reason to set that average higher, and if it is too low, an inspiration request for more funds can always be authored, just as non-profit institutions regularly do in the present economy. The new smartphone age provides individuals a platform on which to present their life goals in a sympathetic light, and already many people facing horrific hardships have been able to raise significant money to enable them to get life-saving operations and other basic needs, by placing their pleas on the Internet. What the present invention does is provide a Curation Validation System for these pleas, so trustworthiness and follow-up and peer support are automatically supplied with some consistency. By enabling individual pleas to successfully compete in levels of trust with, for instance, paid mass-market advertising in the traditional economy, the present invention can move society from a consumption motivated society more humane donation-based society. Knowing how much a person has received in donations, for instance, greatly increases the transparency surrounding that person's opinions. The Currency present invention provides that transparency, to a far greater degree than a currency which permits secret transactions. The present invention enables creation and validation of opinions about exchanges of physical goods and services, as well as delivery of physical labor. These opinions about the value of traditional tangible, physical economic exchanges can effectively take the place of traditional payments systems, by building upon the type of in-kind donation exchanges that non-profits already use to augment cash donations. Yet the present invention enables in-kind donations to be valued, in a fungible, traceable opinion currency, so that unlike cash donations, there is an audit trail of supporting opinions to validate the flow of opinions currency through an entire economy.

Obviously, implementation of the present invention is a social engineering task on a vast scale. Rather than treating people as faceless worker bees of competing companies and bureaucracies, which a Darwinian capitalist society often does, the present invention treats people as individually significant contributors to a system of Opinion Credits, thus publicly elevating individuals to higher reputations as soon as they submit a single opinion verified as valuable to society. This lower bar to recognizing economic contributions to society bypasses the usual hurdles to elevating people from poverty, such as college education, capital requirements and specialized skills. Unlike systems and methods of micro-finance economic development, neither usurious interest rates debt nor any interest rate at all discourages individuals, a particular advantage in cultures where interest rate lending is unpopular or capital is scarce. The only hurdles are literacy and mental competence, both which can be assessed by the Curation Validation System. By crossing those hurdles, a person with no formal education, no personal network, and no capital can get a start with a single opinion submitted via a public library internet web page, and start earning Opinion Credits, that take that person as far and high in economic stature as anybody else in society.

Such a large scale social change can only be done in small increments, with the alternative to current practices immediately at hand in all phases, to prevent harmful social dislocations and budget time for careful testing from an engineering perspective. During implementation, to prevent system failure from unpredictable practical needs, the present invention can be phased in over as many years or decades as necessary. Starting with a modest system to bypass a small fraction (perhaps less than one millionth of total social economic activity) into systems of the present invention, discount coupons, now used by advertising, can be replaced by Opinion Credits for a specific niche industry such as gourmet restaurants. From the very start, holders of Opinion Credits are influential reviewers. Giving discounts to holders gives more bang for the buck than regular coupons, because holders influence many other people. Therefore, Opinion Credits are worth more per dollar of discount.

At the same time, redeemers of Opinion Credits naturally get preferential VIP treatment at hotels, restaurants, retailers and other payments could be made, because they are certified as influential by the Curation Validation System.

The preferred embodiment of implementation of the present invention is to service sectors of the economy where early adopters, with spare economic assets, can burnish their reputations and improve their lifestyles. This enables the technology of the system to be developed and delivered and the staff to be trained for Curation, with an adequate profit margin for rapid expansion. As the System expands further, sectors of the economy with tighter and even bare subsistence operating margins can be covered by the present invention.

As the System expands to offer broader Opinion Credit Redemption Market offerings, potentially in nearly every economic sector, the percentage of discount for the average coupon offering will rise, reflecting increasing consumer confidence in Opinion Credits as an actual basis for economic activity. Finally, when most economic sectors are operating more efficiently with Opinion Credits than convention money, due to increased transparency and trust in decision made using Opinion Credits, the overall percentage of discount for average coupon offerings rises to 90%, as shown in FIG. 3. At the same time, the level of average Percentage of Paid Services and Products, using conventional money falls to 10%. The percentages shown in FIG. 3 are illustrative examples only, and they do not reflect particular numbers which must be achieved in actual implementation. When the use of conventional money falls to 10%, a consumption motivated society will have transformed itself into a humane donation-based society, capable of directly addressing the most crucial goals of society which are the creativity, compassion and authenticity of life.

The advantages of the present invention's increases in transparency of economic decisions extends from better quality customer to service provider relationships, to related issues such as reduction of fraud and discouraging freeloaders on society. Unlike a currency system which allows secret transactions, this system is transparent enough to deter socially undesirable actions such as fraud and market destabilizing market price manipulation. Unlike markets which allow secret transactions, accountability occurs on the level of substantive and intricate thoughts and opinions, rather than the level of simplistic brand packaging and appearances. Rather than constructing contracts on the basis of surface appearance, contracts can thereby be constructed on the basis of true root intention and shared understanding, as well as sincere authentic gratitude, thus bringing optimism, humanity and equality back to a societies suffering from prejudice, injustice and depression.

We claim:

1) A system and method for a market of fungible opinions, wherein actionable economic compensations are fundamentally based on transparent market valuations of individual opinions, verified by curation systems for validating the accuracy and dependability of opinions, and secondarily based on opinions about validated exchanges in physical goods and labor services.

2) A system and method of claim 1 wherein curation systems are partially or fully automated using computer automated text analytics

3) A system and method of claim 1 wherein credit for opinions, and advanced payments of credit for opinions, constitute the majority of goods and services.

4) A system and method of claim 1 wherein credit for opinions, and advanced payments of credit for opinions, are distributed as coupons.
